(19) United States
(12) Patent Application Publication
(10) Pub. No.: US 2022/0134414 A1
(43) Pub. Date: May 5, 2022

(54) SLEEVE WITH RELIEF CAVITY FOR FLANGED TUBE ASSEMBLY

(71) Applicant: Parker-Hannifin Corporation, Cleveland, OH (US)

(72) Inventor: Phillip A. LANDIS, Hilliard, OH (US)

(21) Appl. No.: 17/433,161

(22) PCT Filed: Apr. 9, 2020
(86) PCT No.: PCT/US2020/027385

§ 371 Date: Aug. 23, 2021

Related U.S. Application Data
(60) Provisional application No. 62/834,071, filed on Apr. 15, 2019.

(51) Int. Cl. B21K 21/12; B21K 25/00; F16L 13/16

(52) U.S. Cl. CPC B21K 21/12; F16L 13/166; B21K 25/00

(57) ABSTRACT

A flanged tube assembly includes a rigid tube (10) and a sleeve (12) disposed about an axial end portion of the tube. The axial end portion (18) of the tube (10) includes a flange portion (24) that is formed by the tube wall (36) being radially outwardly deformed over an axial end surface of the sleeve. The sleeve (12) has a radially inner surface (28), and a portion of the tube wall (36) inside of the sleeve (12) is deformed to engage and conform to the radially inner surface of the sleeve, thereby forming a non-welded connection between the sleeve and the tube. The radially inner surface of the sleeve proximal the flange defines a relief cavity (56) that receives the deformed portion of tube wall when the tube wall is deformed during the formation of the flange (24).

### RELATED APPLICATIONS

This application claims the benefit of U.S. Provisional Application No. 62/834,071 filed Apr. 15, 2019, which is hereby incorporated herein by reference in its entirety.

### FIELD OF INVENTION

The present invention relates generally to flanged tube assemblies, and more particularly to a sleeve for a flanged tube assembly and a method for flanging the tube.

### BACKGROUND

A leakproof link between rigid metal tubes, or between a metal tube and the various openings of devices in a system transferring fluid, is often carried out with a flared or flanged connection. One type of flange connection includes a sleeve disposed about a rigid metal tube, with a flange of the tube formed against an axial end of the sleeve, such as by a flange forming die and forming tool. The flange may be cold formed against the axial end of the sleeve by deforming an axial end portion of the rigid metal tube.

Often in forming such a flange, difficulties arise in that the flange forming tool may be prone to damage during the flange forming process. For example, the forming tool may dent, gall, wear, and/or fracture during the flange forming process. In some circumstances, the flange forming tool may break in less than 200 uses, which significantly increases manufacturing costs.

### SUMMARY OF INVENTION

Although the wear and breakage of the flange forming tool is a long-standing problem, changing the forming tool construction, tool geometry, and/or strengthening the material of the forming tool has not provided a solution.

The present inventor has approached the problem differently, and has discovered that the flange forming process creates a bump of excess tube material on the inside diameter of the flange, which creates an increase in the stress and/or force exerted on the forming tool during the flange forming process. This increased stress and/or force exerted by the bump of excess tube material has been found by the present inventor to accelerate wear and/or breakage of the forming tool.

The present invention, therefore, provides an improved sleeve for a flanged tube assembly that includes a relief cavity inside the sleeve that improves material flow during the flanging process of the tube. More particularly, the relief cavity is formed by the radially inner surface of the sleeve proximal the flange, and is configured to receive a volume of tube material when the tube is deformed during the flanging process, thereby mitigating formation of stress risers that otherwise could damage the forming tool.

According to an aspect of the invention, a flanged tube assembly includes: a tube having a longitudinal axis, an axial end portion, a radially inner surface, and a radially outer surface, wherein the radially inner surface and the radially outer surface together define a tube wall therebetween, and wherein the radially inner surface defines a fluid passage for conveying fluid through the tube; a sleeve disposed on the radially outer surface of the tube at the axial end portion of the tube; and the axial end portion of the tube including a flange portion that is formed by the tube wall being radially outwardly deformed over an axial end surface of the sleeve; wherein the sleeve has a radially inner surface, and a portion of the tube wall inside of the sleeve is deformed to engage and conform to the radially inner surface of the sleeve, thereby providing a non-welded connection between the sleeve and the tube; and wherein the radially inner surface of the sleeve proximal the flange portion defines a relief cavity that receives the deformed portion of tube wall when the tube wall is deformed during the formation of the flange portion.

According to another aspect of the invention, a sleeve for a flanged tube assembly includes: a proximal side configured to be proximal a flange portion of a tube, and a distal side configured to be distal the flange portion of the tube, a proximal axial end surface on the proximal side configured for radially outwardly forming the flange portion of the tube thereon, and a radially inner surface configured to engage the tube, wherein the radially inner surface on the proximal side defines a relief cavity that is configured to receive a deformed portion of tube wall when the tube wall is deformed during the formation of the flange portion.

According to another aspect of the invention, a method of making a flanged tube assembly includes: (i) providing a tube having a longitudinal axis, an axial end portion, a radially inner surface, and a radially outer surface, wherein the radially inner surface and the radially outer surface together define a tube wall therebetween, and wherein the radially inner surface defines a fluid passage for conveying fluid through the tube; (ii) providing a sleeve having a radially inner surface, wherein the radially inner surface of the sleeve proximal the flange portion includes a relief cavity; (iii) disposing the exemplary sleeve about the axial end portion of the tube; (iv) deforming the axial end portion of the tube with a forming tool in a direction radially outwardly and axially toward the sleeve to form a flange against an axial end surface of the sleeve; wherein the deforming includes directing material of the axial end portion of the tube into the relief cavity defined by the proximal portion of the radially inner surface of the sleeve.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a perspective view of an exemplary sleeve and an exemplary tube for forming an exemplary flanged tube assembly according to an embodiment of the invention.

FIG. 2 is a cross-sectional side view of the flanged tube assembly formed by the sleeve and tube.

FIG. 3 is an end view of the sleeve.

FIG. 4 is a cross-sectional side view of the sleeve taken about the line A-A in FIG. 3.

FIG. 5 is a cross-sectional side view of an exemplary die and exemplary forming tool shown forming the flanged tube assembly.

FIG. 6 is a chart of load in tons versus time in seconds that was produced using a finite element analysis simulation of a flange forming process using a conventional sleeve.

FIG. 7 is a chart of load in tons versus time in seconds that was produced using a finite element analysis simulation of a flange forming process using the exemplary sleeve in FIGS. 3 and 4.

FIG. 8A is an end view of another exemplary sleeve for forming another exemplary flanged tube assembly.

FIG. 8B is a cross-sectional side view of the sleeve taken about the line C-C in FIG. 8A.

FIG. 9A is an end view of another exemplary sleeve for forming another exemplary flanged tube assembly.

FIG. 9B is a cross-sectional side view of the sleeve taken about the line D-D in FIG. 9A.

FIG. 10A is an end view of another exemplary sleeve for forming another exemplary flanged tube assembly.

FIG. 10B is a cross-sectional side view of the sleeve taken about the line E-E in FIG. 10A.

FIG. 11A is an end view of another exemplary sleeve for forming another exemplary flanged tube assembly.

FIG. 11B is a cross-sectional side view of the sleeve taken about the line F-F in FIG. 11A.

FIG. 12A is an end view of another exemplary sleeve for forming another exemplary flanged tube assembly.

FIG. 12B is a cross-sectional side view of the sleeve taken about the line G-G in FIG. 12A.

FIG. 13A is an end view of another exemplary sleeve for forming another exemplary flanged tube assembly.

FIG. 13B is a cross-sectional side view of the sleeve taken about the line H-H in FIG. 13A.

### DETAILED DESCRIPTION

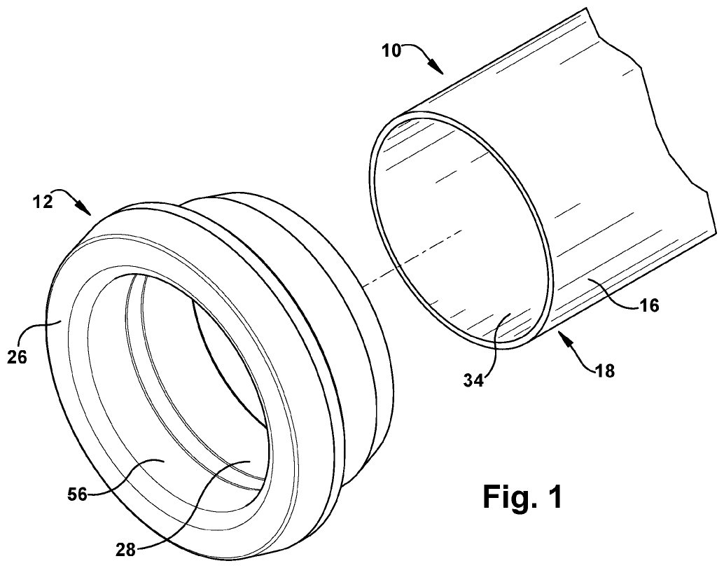

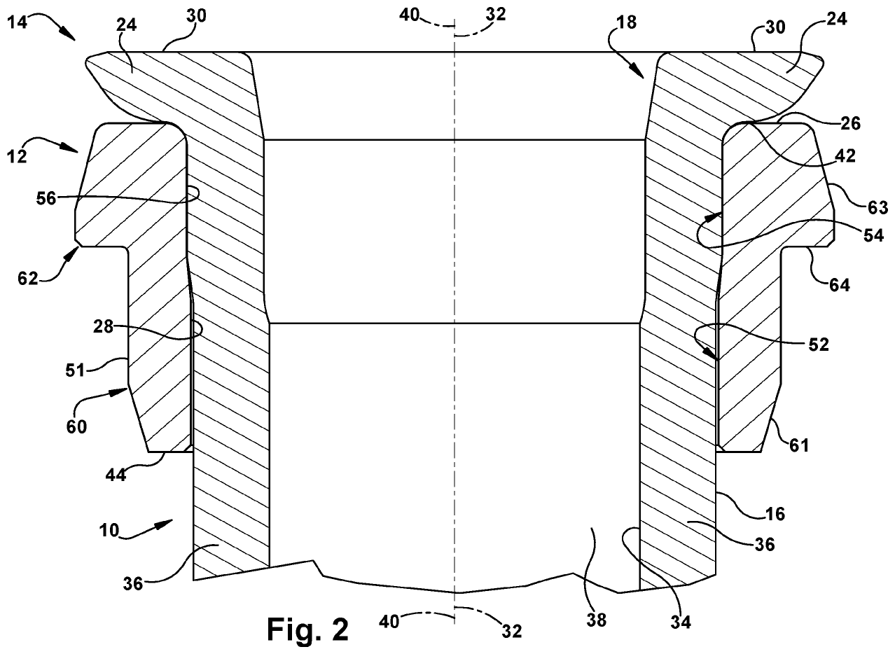

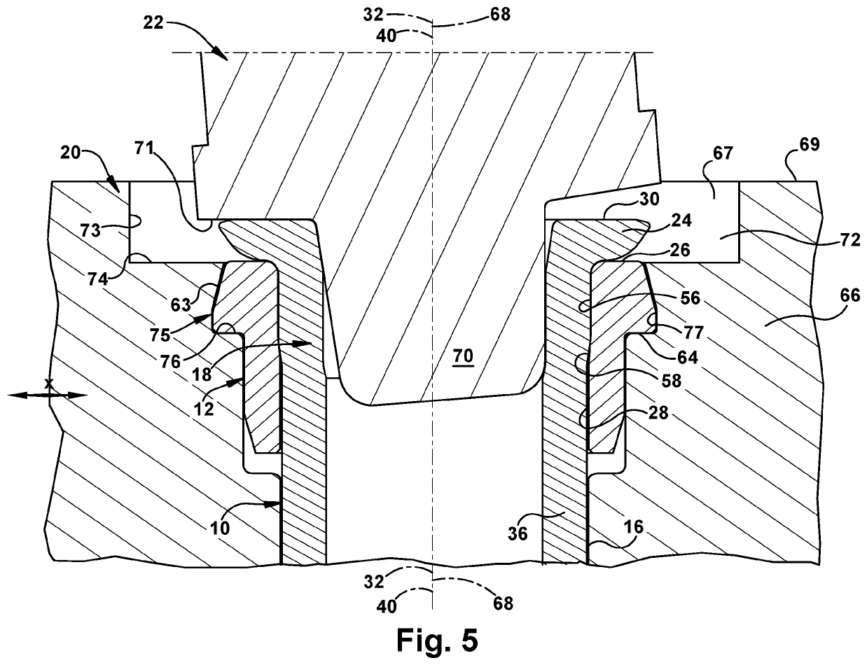

An exemplary tube 10 and an exemplary sleeve 12 are shown in FIG. 1 for providing an exemplary flanged tube assembly 14, as shown in FIG. 2. The sleeve 12 generally has an annular shape and is disposed on a radially outer surface 16 of the tube 10. As discussed in further detail below, an axial end portion 18 of the tube 10 extends through the sleeve 12 and is radially outwardly deformed, such as with a die 20 and a flange forming tool 22 (FIG. 5), to form a flange portion 24 of the tube 10 that extends over an axial end surface 26 of the sleeve 12. The axial end portion 18 of the tube 10 inside of the sleeve 12 also is deformed during the flange forming process to engage and conform to a radially inner surface 28 of the sleeve 12. This formation of the flange portion 24 and conformance of the tube 10 to the sleeve 12 provides a non-welded connection between the sleeve 12 and the tube 10. Such a flanged tube assembly 14 generally includes an axial end face 30, which provides a sealing face 30 for seating against an external sealing element (not shown). In this manner, the flange connection provided by the flanged tube assembly 14 may be utilized to make a leak-proof fluid connection with another fluid conduit for conveying fluid, such as hydraulic fluid, through the tube 10.

In exemplary embodiments, the tube 10 is a rigid metal tube about which the sleeve 12 is received. The tube 10 generally includes a longitudinal axis 32, the axial end portion 18, the radially outer surface 16, and a radially inner surface 34. The radially inner surface 34 and the radially outer surface 16 together define a tube wall 36 therebetween, and the radially inner surface 34 defines a fluid passage 38 for conveying fluid through the tube. In the illustrated embodiment, the tube 10 extends along the longitudinal tube axis 32, which as depicted, is co-linear with a longitudinal axis 40 of the sleeve 12. It is understood, however, that the tube 10 may include one or more bent portions along the length of the tube 10.

The tube 10 is rigid in that it maintains its shape disposed along the central longitudinal tube axis 32 absent external forces acting on the tube 10. The flange formation process, discussed in further detail below, may be particularly optimized for use with thin-walled tubes, such as having a tube wall thickness between about 0.020 inches to about 0.100 inches, although tubes with greater wall thicknesses may be used The tube 10 may be made of any material suitable for having the flange portion 24 formed at its axial end portion 18, such as stainless steel, plain-carbon steel, copper, brass, aluminum, and the like.

As discussed below, a forming tool 22 engaging the axial end portion 18 of the tube 10 causes deformation of the tube wall 36 to form into the flange portion 24 (also referred to as the flange 24). As shown, the material of the tube wall 36 forming the flange 24 may extend radially outwardly over the axial end surface 26 of the sleeve 12 proximal the flange 24. In this manner, the flange 24 includes a mating surface 42 formed by the tube wall 36 that engages and conforms to the axial end surface 26 of the sleeve 12 when the tube 10 is deformed. As mentioned above, the axial end portion 18 of the tube 10 inside of the sleeve 12 also is deformed during the flange forming process to engage and conform to the radially inner surface 28 of the sleeve 12, thereby providing a non-welded flange connection.

Also due to the deformation of the axial end portion 18 of the tube 10, the flange 24 includes the axial end face 30, which serves as the sealing surface of the flange 24. In exemplary embodiments, the sealing surface 30 is generally planar and disposed in a plane generally perpendicular to the central longitudinal axis 32, 40 of the sleeve 12 and the tube 10. Generally, an outer diameter of the sealing surface 30, and also an axial thickness of the flange 24, may be controlled via the configuration and use of the die 20 and/or forming tool 22.

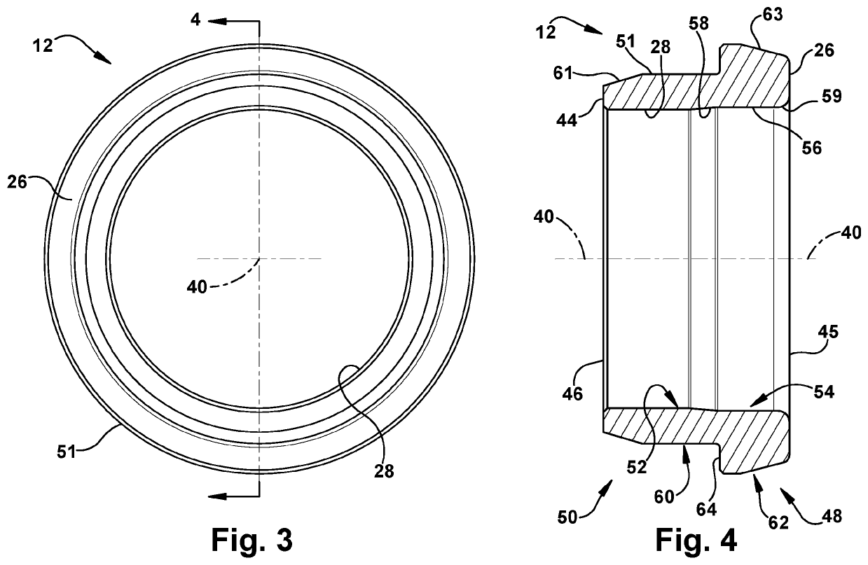

Referring to FIGS. 3 and 4, the exemplary sleeve 12 will now be described in further detail. As shown, the sleeve 12 is generally annular shaped about the longitudinal axis 40 and includes opposite axial end surfaces 26, 44 with openings 45, 46 that are configured for inserting the tube 10 therethrough. The sleeve 12 generally includes a proximal side 48 that is configured to be proximal the flange 24 when formed (as shown in FIG. 2), and a distal side 50 that is configured to be distal the flange 24 when formed. Throughout the remainder of the description, the portions of the sleeve 12 that are closer to the flange 24 when formed (FIG. 2) will be described as proximal portions, and the portions of the sleeve 12 that are further from the flange 24 when formed will be described as distal portions.

The sleeve 12 includes a radially inner surface 28 and a radially outer surface 51 that together define a sleeve wall therebetween. The radially outer surface 51 generally is configured for insertion of the sleeve 12 in the die 20 and formation of the flange 24 over the proximal end surface 26 of the sleeve (see e.g., FIG. 5, described below). The radially inner surface 28 of the sleeve 12 is configured for being supported on the tube 10 and for mating with the radially outer surface 16 of the tube when the axial end portion 18 of the tube wall 36 inside of the sleeve 12 is deformed during the flange forming process to form a permanent flanged connection between the tube 10 and the sleeve 12.

As shown, the radially inner surface 28 of the sleeve 12 generally extends in the axial direction between the distal end surface 44 and the proximal end surface 26. The radially inner surface 28 encompasses the longitudinal axis 40, and includes an axially distal portion 52 of the inner surface 28 that is distal the flange 24 (when formed), and an axially proximal portion 54 of the inner surface 28 that is proximal the flange 24 (when formed). As shown, the proximal portion 54 of the radially inner surface 28 defines a relief cavity 56 inside of the sleeve 12. In exemplary embodiments, the relief cavity 56 defined by the proximal portion 54 is radially outwardly enlarged relative to at least a portion of the distal portion 52 of the radially inner surface 28, and is configured to receive a deformed portion of the tube wall 36 when the flange 24 is formed, as further detailed below.

As discussed above, conventional sleeves have been found to cause difficulties in the flange forming process due to damage of the flange forming tool (e.g., 22). For example, the flange forming process with conventional sleeves may result in dent, gall, wear, and/or fracture of the forming tool during the flange forming process. In some circumstances, the flange forming tool may break in less than 200 uses, which significantly increases manufacturing costs.

Such conventional sleeves have a radially inner surface with a uniform or constant inner diameter along the entire length of the sleeve, and the present inventor has discovered that the flange forming process with such conventional sleeves creates a bump of excess tube material on the inside diameter of the flange, which creates an increase in the stress and/or force exerted on the forming tool during the flange forming process. The present inventor has considered that this increased stress and/or force exerted by the bump of excess tube material accelerates the wear and/or breakage of the forming tool.

The relief cavity 56 provided inside the exemplary sleeves 12 is configured to receive a volume of the deformed tube material during the flanging process of the tube 10, which reduces or eliminates the formation of a bump of excess material inside of the tube 10. In other words, the relief cavity 56 is configured to provide a sufficiently large enough volume for receiving the excess material that is displaced during deformation of the tube 10 to thereby minimize or eliminate bunching of the material inside the tube 10. This minimization or elimination of the bump of excess material minimizes stress concentration points inside of the tube 10 that otherwise could damage the forming tool 22, which thereby enhances the life of the tool 22. In addition, the relief cavity 56 also is configured such that its volume is not so large that not enough tube material can flow into and fill the cavity 56 so as to prevent the formation of gaps between the sleeve 12 and tube 10. In this manner, the radially inner surface 28 defining the relief cavity 56 may be configured with an axial length, radial width, and/or shape for providing the desired volume to prevent bunching of the tube material and prevent gaps between the sleeve 12 and the tube 10. Those having ordinary skill in the art would readily understand the desired configuration of the relief cavity 56 depending on the particular application or range of applications, which at least partially depends on the amount of tube material desired to be displaced during the flange forming process.

In the illustrated embodiment, the proximal portion 54 of the radially inner surface 28 defining the relief cavity 56 extends in the axial direction with a constant or uniform diameter. Such a configuration may enable greater uniformity in displacing the tube material during the flanging process without bunching of the material. In addition, the distal portion 52 of the radially inner surface 28 extends in the axial direction with a constant or uniform diameter. As shown, the diameter of the proximal portion 54 defining the relief cavity 56 is greater than the diameter of the distal portion 52. The radially inner surface 28 of the sleeve 12 also includes a tapered surface 58 that connects the narrower distal portion 52 with the wider proximal portion 54 defining the relief cavity 56. This tapered surface 58 is radially outwardly tapered as it extends toward the proximal end 26, and serves as a gradual transition that helps to prevent a sharp edge from forming at the tube wall 36 between the proximal portion 54 having the relief cavity 56 and the distal portion 52.

In exemplary embodiments, the sleeve 12 includes a curved surface 59 that connects the proximal axial end surface 26 of the sleeve 12 with the proximal portion 54 of the radially inner surface 28. Such curvature may prevent a sharp edge from forming at the tube wall 36 as the flange portion 24 of the tube 10 is formed over the proximal end surface 26. In the illustrated embodiment, the proximal end surface 26 of the sleeve is a flat surface that is perpendicular to the longitudinal axis 40. Such a flat surface may facilitate formation of the axial end face 30 of the flange 24 as a flat surface for providing a flat sealing face for connection to a sealing element and/or other fluid conduit.

As mentioned above, the radially outer surface 51 of the sleeve 12 generally is configured for insertion of the sleeve 12 in the die 20 and formation of the flange 24 over the sleeve 12 (as shown in FIG. 5, for example, and described below). In exemplary embodiments, the radially outer surface 51 has a distal narrow portion 60 and a proximal land portion 62, in which the land portion 62 protrudes radially outwardly relative to the narrow portion 60. As shown, the narrow portion 60 includes a tapered surface 61 at the distal end of the sleeve 12 that is tapered radially inwardly toward the tube 10. The land portion 62 includes a distal land surface 64 that serves as a seat for supporting the sleeve 12 in the die 20. The land portion 62 also includes the proximal axial end surface 26 of the sleeve 12 (also referred to as a proximal land 26) over which flange portion 24 of the tube 10 is formed. As shown, a radially outer surface of the land portion 62 also may include a tapered surface 63 toward the proximal end 26 that is tapered radially inwardly toward the tube 10, and which is configured to cooperate with the die 20 for improving the formation of the flange 24.

Referring to FIG. 5, the exemplary die 20 and flange forming tool 22 are shown forming the flange portion 24 of the tube 10 over the sleeve 12 to form the flanged tube assembly 14. The die 20 generally has a die body 66 having a passage 67 extending through the die body 66 along a longitudinal die axis 68. The passage 67 may be generally cylindrical in shape and extends centrally through the die body 66. The cylindrical shape includes varying diameters due to the passage 67 being stepped along the length of the longitudinal die axis 68. The die body 66 has a proximal end face 69 and a distal end face (not shown) disposed opposite the proximal end face 69, between which the passage 67 extends in the die body 66. The terms proximal and distal refer to locations relative to a forming tool 22 for which the die 20 is configured to be engaged by to form the flange 24.

The die body 66 may have a substantially quadrilateral shape, such as a substantially square shape, although other shapes may be suitable. The die 20 is formed from a suitable metal such as steel. Other materials may be suitable in other embodiments. The die 20 generally is configured for being placed in a flange forming device (not shown), and may include alignment features such that the die 20 may be retained in the device having the forming tool 22.

As shown in the illustrated embodiment, the sleeve 12 and the tube 10 are secured in the passage 67 of the die 20 such that the longitudinal tube axis 32 and the longitudinal flange axis 40 are aligned with, such as being co-linear with, the longitudinal die axis 68. The passage 67 is configured to retain the sleeve 12 and the tube 10 while the forming tool 22, such as an orbitally moving pin 22, is axially advanced along the longitudinal die axis 68 into engagement with the proximal axial end portion 18 of the tube 10 to form the flange 24. The pin 22 includes a centrally-located protrusion 70 for being received into the tube 10, and a radially-outer portion 71 for engaging the proximal end of the tube 10.

At the most proximal end of the passage 67, an open area 72 is defined by the die body 66 for receiving the pin 22. The open area 72 circumscribes the longitudinal die axis 68 and is located distally of the proximal end face 69. The open area 72 includes a radially inwardly directed surface 73 that extends axially between the proximal end face 30 and a proximal shelf 74 of the open area 72. The axial length of the surface 73 along the longitudinal die axis 68 is about equal to the corresponding length of a particular tube 10 having a particular diameter and wall thickness that is necessary to form a particular flange 24 at the proximal end portion 18 of the tube 10. For example, the proximal end portion 18 of the tube 10 may be received into the open area 72 and into abutment with a tube locator (not shown) that is selectively engaged at the proximal end face 69 of the die 20, prior to being retracted to allow for advancement of the pin 22 into engagement with the proximal end portion 18 of the tube 10. Furthermore, an axial distance between the proximal shelf 74 and the radially-outer portion 71 may be controlled via selective adjustment of the die 20 to control the dimensions of the flange 24. For example, in a well-known manner, the die 20 may include adjustment members (not shown) that allow fine adjustment for the distance between the proximal shelf 74 and the maximum distally-advanced position of the radially-outer portion 71.

The die body 66 further defines a sleeve recess 75 axially disposed between the proximal shelf 74 and an intermediate shelf 76. The intermediate shelf 76 is distally spaced along the longitudinal die axis 68 from the proximal shelf 74. The distal land 64 of the sleeve 12 is engaged against the intermediate shelf 76 when the sleeve 12 is received into the passage 67, thereby providing an axially located seating surface to axially align the sleeve 12 relative to the proximal end face 69 of the die 20. Both the proximal shelf 74 and the intermediate shelf 76 are depicted as being generally flat surfaces disposed in respective planes that are parallel to one another and generally orthogonal to the longitudinal die axis 68.

The sleeve recess 75 includes a distally-located containment surface 77. The containment surface 77 is a radially inwardly directed surface of the sleeve recess 75 that is configured for retaining and supporting the proximal portion 48 of the sleeve 12. The containment surface 77 engages the radially outermost surface of the land portion 62 of the sleeve 12 and may have a constant diameter along the longitudinal die axis 68.

Still referring to FIG. 5, an exemplary method for forming the flange 24 from the axial end portion 18 of the rigid tube 10 received into the sleeve 12 will now be described. The method includes the steps of (a) providing the exemplary sleeve 12 disposed about the rigid tube 10, and (b) introducing the sleeve 12 into a sleeve recess 75 of the die 20 such that at least the radially outermost extent of the sleeve 12 is circumferentially supported by the sleeve recess 75. The method further includes the steps of (c) translating the rigid tube 10 within the sleeve 12 to extend axially from the sleeve recess 75 of the die 20, and (d) actuating the tool 22 with an orbital movement and progressively advancing the tool 22 towards the die 20. The method further includes (e) deforming the axial end portion 18 of the rigid tube 10 in a direction radially outwardly and axially inwardly (i.e., distally) toward the sleeve 12 to form the flange 24 against the axial end surface 26 of the sleeve 12. The method may include the step of selectively adjusting the die 20 to provide for adjustment of a thickness of the flange 24 along the longitudinal die axis 68.

The deforming step also includes directing material of the axial end portion 18 of the tube 10 into the relief cavity 56 defined by the proximal portion 54 of the radially inner surface 28 of the sleeve 12. As discussed above, the relief cavity 56 is configured to receive a volume of the deformed tube material during the flanging process of the tube 10, which reduces or eliminates the bunching of excess material inside of the tube 10. In this manner, the deformed tube material directed into the relief cavity 56 preferably fills the entire volume of the cavity 56, and conforms at least the radially outer portion of the deformed tube wall 36 to the radially inner surface 28 of the sleeve 12 defining the relief cavity 56.

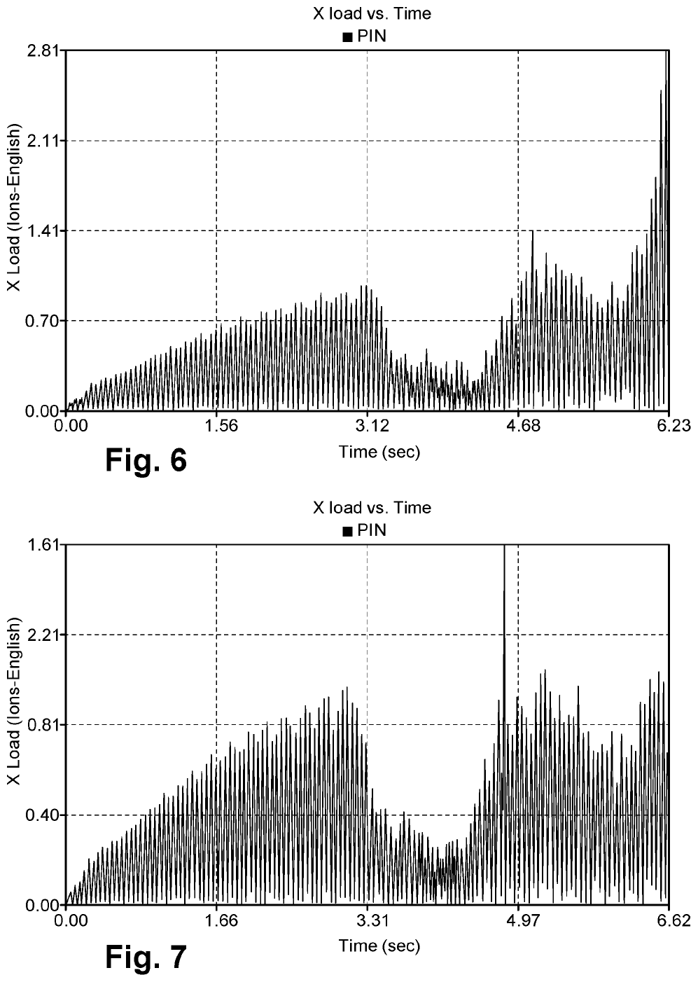

Turning to FIGS. 6 and 7, comparative finite element analysis simulation data shows the load (tons) vs. time (seconds) exerted on the pin of the forming tool in the X-direction (illustrated in FIG. 5) during the flange forming process using a conventional sleeve with a constant (uniform) inner diameter (simulation data shown in FIG. 6) compared to the exemplary sleeve 12 of FIGS. 3 and 4 having the exemplary relief cavity 56 (simulation data shown in FIG. 7).

As shown in FIG. 6, at about 6.2 seconds of forming the flange with the conventional sleeve with the constant inner diameter, the maximum radial or side load on the pin increases to about 2.5 tons of force. As discussed above, the present inventor discovered that flange forming with the conventional sleeve created a bump of excess tube material on the inside diameter of the flange. which is believed to create the increased force on the pin during the flange forming process, as shown in FIG. 6. The present inventor has considered that this increased force and/or stress accelerates wear and/or breakage of the forming tool.

In contrast, as shown in FIG. 7, at about 6.6 seconds of forming the flange with the exemplary sleeve 12 having the relief cavity 56, the maximum radial or side load on the pin increases only to about 1.1 tons. As discussed above, the relief cavity 56 is configured to receive a volume of the deformed tube material during the flanging process of the tube, which is found to reduce or eliminate the formation of a bump of excess material inside of the tube. Minimizing the formation of the bump in this way should cause the lower radial or side load on the flanging tool, as shown in FIG. 7. The exemplary sleeve 12 also is found to provide sufficient volume to enable the deformed tube material to fill the volume provided by the relief cavity 56 such that the deformed tube wall conformed to the radially inner surface 28 of the sleeve 12 defining the cavity 56 without any significant gaps.

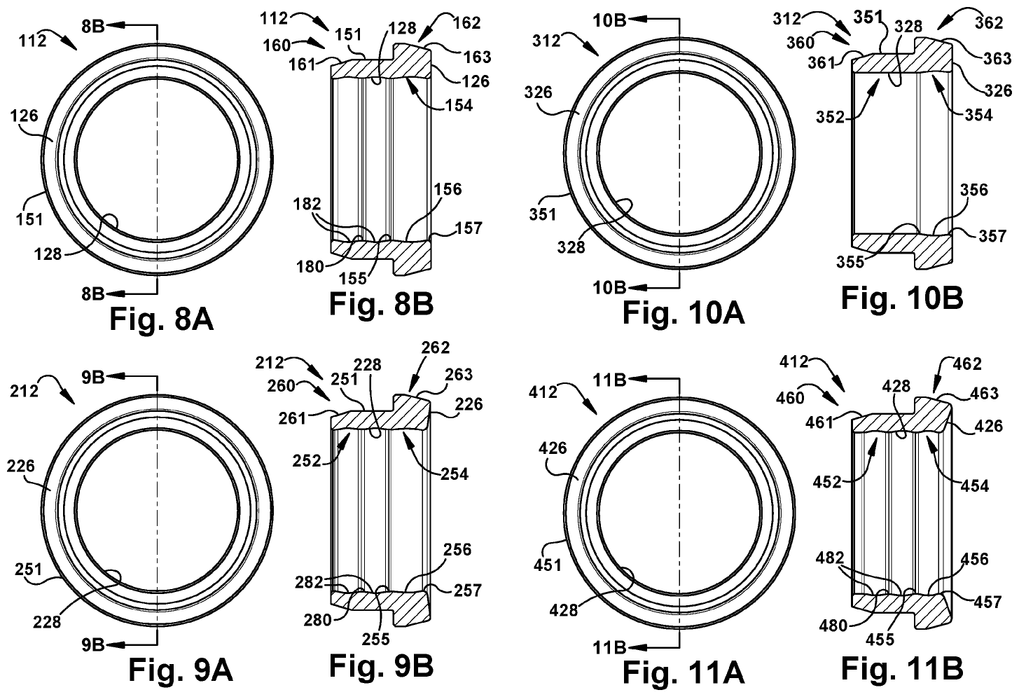

Turning to FIGS. 8A-13B, alternative embodiments of exemplary sleeves (112, 212, 312, 412, 512, 612) having exemplary relief cavities for forming flanged tube assemblies are shown. The sleeves 112-612 are substantially similar to the above-referenced sleeve 12, and consequently similar reference numerals (but successively indexed by 100 for each successive embodiment) are used to denote structures corresponding to similar structures in the respective sleeves 12 and 112-612. In addition, the foregoing description of the sleeve 12 is equally applicable to the sleeves 112-612, except as noted below. Moreover, it is understood that aspects of the sleeves 12 and 112-612 may be substituted for one another or used in conjunction with one another where applicable.

Referring to FIGS. 8A and 8B, an exemplary sleeve 112 is shown. As shown, the radially outer surface 151 of the sleeve is essentially the same as the radially outer surface 51 of the sleeve 12, including a distal narrow portion 160 and a proximal land portion 162, with respective tapered surfaces 161 and 163. In the illustrated embodiment, the proximal end surface 126 of the sleeve 112 is a flat surface that is perpendicular to the longitudinal axis.

In the illustrated embodiment, the radially inner surface 128 of the sleeve 112 includes an axially distal portion 152 that is distal the flange (when formed) and an axially proximal portion 154 that is proximal the flange (when formed). As shown, the proximal portion 154 of the radially inner surface 128 defines a relief cavity 156 inside of the sleeve 112. The relief cavity 156 defined by the proximal portion 154 is radially outwardly enlarged relative to at least a portion of the distal portion 152 of the inner surface 128, such as relative to a portion 155 of the inner surface 128 that is adjacent to the proximal portion 154 that defines the relief cavity 156. As discussed above, the relief cavity 156 is configured with a volume to receive a volume of deformed material from the tube wall when the flange is formed, so as to reduce or minimize the bunching of the deformed material at the inside of the tube wall.

In the illustrated embodiment, the proximal portion 154 of the radially inner surface defining the relief cavity 156 is curved in the axial direction, which thereby forms opposite proximal 157 and distal (also referred to with reference numeral 155) ridges on opposite sides of the relief cavity 156. In this manner, the radially outward apex of the curved surface defining the relief cavity 156 has a diameter that is greater than a diameter at the distal ridge 155. Also as shown, the distal portion 152 of the radially inner surface of the sleeve includes one or more radially inwardly protruding ridges 180 and one or more radially outwardly recessed grooves 182 that together provide a grip for engaging the radially outer surface of the tube.

Referring to FIGS. 9A and 9B, an exemplary sleeve 212 is shown. As shown, the radially outer surface 251 of the sleeve is essentially the same as the radially outer surface 51 of the sleeve 12, including a distal narrow portion 260 and a proximal land portion 262, with respective tapered surfaces 261 and 263. In the illustrated embodiment, the proximal axial end surface 226 of the sleeve 212 is an inclined surface that is inclined to a plane perpendicular to the longitudinal axis. As shown, the inclined axial end surface 226 extends radially outwardly as the inclined surface 226 extends in the axial direction toward the flange (when formed).

In the illustrated embodiment, the radially inner surface 228 of the sleeve 212 includes an axially distal portion 252 that is distal the flange (when formed) and an axially proximal portion 254 that is proximal the flange (when formed). As shown, the proximal portion 254 of the radially inner surface 228 defines a relief cavity 256 inside of the sleeve 212. The relief cavity 256 defined by the proximal portion 254 is radially outwardly enlarged relative to at least a portion of the distal portion 252 of the inner surface 228, such as relative to a portion 255 of the inner surface 228 that is adjacent to the proximal portion 254 that defines the relief cavity 256. As discussed above, the relief cavity 256 is configured with a volume to receive a volume of deformed material from the tube wall when the flange is formed, so as to reduce or minimize the bunching of the deformed material at the inside of the tube wall.

In the illustrated embodiment, the proximal portion 254 of the radially inner surface defining the relief cavity 256 is curved in the axial direction, which thereby forms opposite proximal 257 and distal (also referred to with reference numeral 255) ridges on opposite sides of the relief cavity 256. In this manner, the radially outward apex of the curved surface defining the relief cavity 256 has a diameter that is greater than a diameter at the distal ridge 255. Also as shown, the distal portion 252 of the radially inner surface of the sleeve includes one or more radially inwardly protruding ridges 280 and one or more radially outwardly recessed grooves 282 that together provide a grip for engaging the radially outer surface of the tube.

Referring to FIGS. 10A and 10B, an exemplary sleeve 312 is shown. As shown, the radially outer surface 351 of the sleeve 312 is essentially the same as the radially outer surface 51 of the sleeve 12, including a distal narrow portion 360 and a proximal land portion 362, with respective tapered surfaces 361 and 363. In the illustrated embodiment, the proximal end surface 326 of the sleeve 312 is a flat surface that is perpendicular to the longitudinal axis.

In the illustrated embodiment, the radially inner surface 328 of the sleeve 312 includes an axially distal portion 352 that is distal the flange (when formed) and an axially proximal portion 354 that is proximal the flange (when formed). As shown, the proximal portion 354 of the radially inner surface defines a relief cavity 356 inside of the sleeve 312. The relief cavity 356 defined by the proximal portion 354 is radially outwardly enlarged relative to at least a portion of the distal portion 352 of the inner surface 328, such as relative to a portion 355 of the inner surface 328 that is adjacent to the proximal portion 354 that defines the relief cavity 356. As discussed above, the relief cavity 356 is configured with a volume to receive a volume of deformed material from the tube wall when the flange is formed, so as to reduce or minimize the bunching of the deformed material at the inside of the tube wall.

In the illustrated embodiment, the proximal portion 354 of the radially inner surface defining the relief cavity 356 is curved in the axial direction, which thereby forms opposite proximal 357 and distal (also referred to with reference numeral 355) ridges on opposite sides of the relief cavity 356. In this manner, the radially outward apex of the curved surface defining the relief cavity 356 has a diameter that is greater than a diameter at the distal ridge 355. Also as shown, the distal portion 352 of the radially inner surface of the sleeve has a constant and uniform diameter as the distal portion 352 extends in the axial direction from the distal ridge 355 toward the distal end of the sleeve 312.

Referring to FIGS. 11A and 11B, an exemplary sleeve 412 is shown. As shown, the radially outer surface 451 of the sleeve 412 is essentially the same as the radially outer surface 51 of the sleeve 12, including a distal narrow portion 460 and a proximal land portion 462, with respective tapered surfaces 461 and 463. In the illustrated embodiment, the proximal axial end surface 426 of the sleeve 412 is an inclined surface that is inclined to a plane perpendicular to the longitudinal axis. As shown, the inclined axial end surface 426 extends radially outwardly as the inclined surface 426 extends in the axial direction toward the flange (when formed). In the illustrated embodiment, the incline of the inclined surface 426 is greater than the incline of the inclined surface 226 of the sleeve 212 in FIGS. 9A and 9B.

In the illustrated embodiment, the radially inner surface 428 of the sleeve 412 includes an axially distal portion 452 that is distal the flange (when formed) and an axially proximal portion 454 that is proximal the flange (when formed). As shown, the proximal portion 454 of the radially inner surface 428 defines a relief cavity 456 inside of the sleeve 412. The relief cavity 456 defined by the proximal portion 454 is radially outwardly enlarged relative to at least a portion of the distal portion 452 of the inner surface 428, such as relative to a portion 455 of the inner surface 428 that is adjacent to the proximal portion 454 that defines the relief cavity 456. As discussed above, the relief cavity 456 is configured with a volume to receive a volume of deformed material from the tube wall when the flange is formed, so as to reduce or minimize the bunching of the deformed material at the inside of the tube wall.

In the illustrated embodiment, the proximal portion 454 of the radially inner surface defining the relief cavity 456 is curved in the axial direction, which thereby forms opposite proximal 457 and distal (also referred to with reference numeral 455) ridges on opposite sides of the relief cavity 456. In this manner, the radially outward apex of the curved surface defining the relief cavity 456 has a diameter that is greater than a diameter at the distal ridge 455. Also as shown, the distal portion 452 of the radially inner surface of the sleeve includes one or more radially inwardly protruding ridges 480 and one or more radially outwardly recessed grooves 482 that together provide a grip for engaging the radially outer surface of the tube.

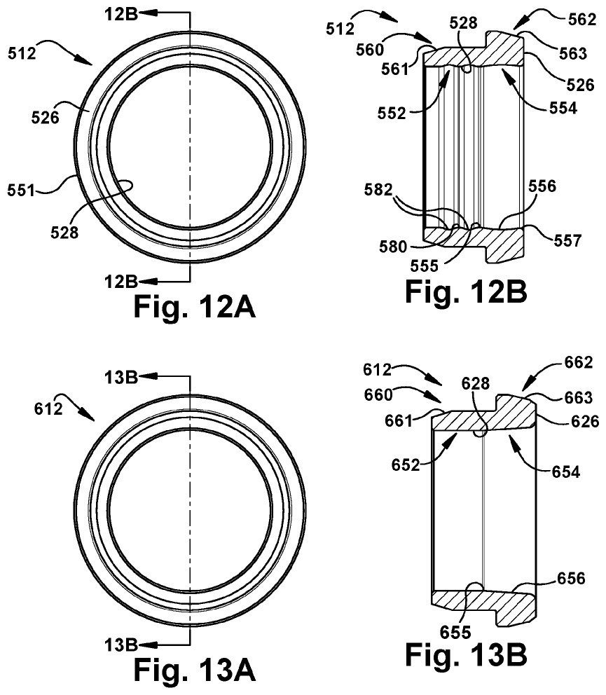

Referring to FIGS. 12A and 12B, an exemplary sleeve 512 is shown. As shown, the radially outer surface 551 of the sleeve 512 is essentially the same as the radially outer surface 51 of the sleeve 12, including a distal narrow portion 560 and a proximal land portion 562, with respective tapered surfaces 561 and 563. In the illustrated embodiment, the proximal end surface 526 of the sleeve is a flat surface that is perpendicular to the longitudinal axis.

In the illustrated embodiment, the radially inner surface 528 of the sleeve 512 includes an axially distal portion 552 that is distal the flange (when formed) and an axially proximal portion 554 that is proximal the flange (when formed). As shown, the proximal portion 554 of the radially inner surface 528 defines a relief cavity 556 inside of the sleeve 512. The relief cavity 556 defined by the proximal portion 554 is radially outwardly enlarged relative to at least a portion of the distal portion 552 of the inner surface 528, such as relative to a portion 555 of the inner surface 528 that is adjacent to the proximal portion 554 that defines the relief cavity 556. As discussed above, the relief cavity 556 is configured with a volume to receive a volume of deformed material from the tube wall when the flange is formed, so as to reduce or minimize the bunching of the deformed material at the inside of the tube wall.

In the illustrated embodiment, the proximal portion 554 of the radially inner surface defining the relief cavity 556 is curved in the axial direction, which thereby forms opposite proximal 557 and distal (also referred to with reference numeral 555) ridges on opposite sides of the relief cavity 556. In this manner, the radially outward apex of the curved surface defining the relief cavity 556 has a diameter that is greater than a diameter at the distal ridge 555. Also as shown, the distal portion 552 of the radially inner surface of the sleeve includes one or more radially inwardly protruding ridges 580 and one or more radially outwardly recessed grooves 582 that together provide a grip for engaging the radially outer surface of the tube. In the illustrated embodiment, the radially outwardly recessed grooves 582 are axially spaced apart with less spacing than the spacing provided by the recessed grooves 182 of the distal portion 152 of the sleeve 112 shown in FIGS. 8A and 8B.

Referring to FIGS. 13A and 13B, an exemplary sleeve 612 is shown. As shown, the radially outer surface 651 of the sleeve 612 is essentially the same as the radially outer surface 51 of the sleeve 12, including a distal narrow portion 660 and a proximal land portion 662, with respective tapered surfaces 661 and 663. In the illustrated embodiment, the proximal end surface 626 of the sleeve 612 is a flat surface that is perpendicular to the longitudinal axis.

In the illustrated embodiment, the radially inner surface 628 of the sleeve 612 includes an axially distal portion 652 that is distal the flange (when formed) and an axially proximal portion 654 that is proximal the flange (when formed). As shown, the proximal portion 654 of the radially inner surface 628 defines a relief cavity 656 inside of the sleeve 612. The relief cavity 656 defined by the proximal portion 654 is radially outwardly enlarged relative to at least a portion of the distal portion 652 of the inner surface 628, such as relative to a portion 655 of the inner surface 628 that is adjacent to the proximal portion 654 that defines the relief cavity 656. As discussed above, the relief cavity 656 is configured with a volume to receive a volume of deformed material from the tube wall when the flange is formed, so as to reduce or minimize the bunching of the deformed material at the inside of the tube wall.

In the illustrated embodiment, the proximal portion 654 of the radially inner surface defining the relief cavity 656 is radially outwardly tapered as the radially inner surface 628 extends in the axial direction toward the proximal end surface 626. In this manner, a diameter of the tapered surface that defines the relief cavity 656 gradually increases in the axial direction toward the proximal end surface 626, in which this diameter at any point is greater than the diameter at the distal portion 652 (and/or portion 655). As shown, the distal portion 652 of the radially inner surface 628 of the sleeve has a constant and uniform diameter as the distal portion 652 extends in the axial direction.

According to an aspect of the invention, a flanged tube assembly includes: a tube having a longitudinal axis, an axial end portion, a radially inner surface, and a radially outer surface, wherein the radially inner surface and the radially outer surface together define a tube wall therebetween, and wherein the radially inner surface defines a fluid passage for conveying fluid through the tube; a sleeve disposed on the radially outer surface of the tube at the axial end portion of the tube; and the axial end portion of the tube including a flange portion that is formed by the tube wall being radially outwardly deformed over an axial end surface of the sleeve; wherein the sleeve has a radially inner surface, and a portion of the tube wall inside of the sleeve is deformed to engage and conform to the radially inner surface of the sleeve, thereby providing a non-welded connection between the sleeve and the tube; and wherein the radially inner surface of the sleeve proximal the flange portion defines a relief cavity that receives the deformed portion of tube wall when the tube wall is deformed during the formation of the flange portion.

Embodiments of the invention may include one or more of the following additional features, separately or in any combination.

In some embodiments, the radially inner surface of the sleeve includes a distal portion that is distal the flange portion and a proximal portion that is proximal the flange portion, the proximal portion defining the relief cavity, and wherein the proximal portion defining the relief cavity is radially outwardly enlarged relative to the distal portion.

In some embodiments, the proximal portion defining the relief cavity extends in an axial direction with a uniform diameter; wherein the distal portion extends in the axial direction with a uniform diameter; and wherein the diameter of the proximal portion defining the relief cavity is greater than the diameter of the distal portion.

In some embodiments, the radially inner surface of the sleeve further includes a radially outwardly tapered surface that connects the distal portion with the proximal portion defining the relief cavity.

In some embodiments, the proximal portion defining the relief cavity is curved in the axial direction.

In some embodiments, the proximal portion defining the relief cavity is radially outwardly tapered as the radially inner surface extends in the axial direction toward the flange portion.

In some embodiments, the axial end surface of the sleeve proximal the flange portion is a flat surface that is perpendicular to the longitudinal axis.

In some embodiments, the axial end surface of the sleeve proximal the flange portion is an inclined surface that is inclined to a plane perpendicular to the longitudinal axis, the inclined surface extending radially outwardly as the inclined surface extends in the axial direction toward the flange portion.

In some embodiments, the distal portion of the radially inner surface of the sleeve includes one or more radially inwardly protruding ridges and one or more radially outwardly recessed grooves that together provide a grip for engaging the radially outer surface of the tube.

In some embodiments, the distal portion of the radially inner surface of the sleeve has a uniform diameter as the distal portion extends in the axial direction.

In some embodiments, the sleeve has a radially outer surface, the radially outer surface having a narrow portion distal the flange portion, and the radially outer surface having a land portion proximal the flange portion that radially outwardly protrudes relative to the narrow portion.

In some embodiments, the narrow portion of the radially outer surface includes a tapered surface at a distal end of the sleeve that is tapered radially inwardly toward the tube.

In some embodiments, the land portion of the radially outer surface includes a tapered surface toward a proximal end of the sleeve that is tapered radially inwardly toward the tube.

In some embodiments, the flange portion includes a mating surface formed by the tube wall that engages and conforms to the axial end surface of the sleeve when the tube is deformed.

In some embodiments, the flange portion has an axial end face formed by the tube wall that is flat and perpendicular to the longitudinal axis.

According to another aspect of the invention, a method of making a flanged tube assembly includes: providing a tube having a longitudinal axis, an axial end portion, a radially inner surface, and a radially outer surface, wherein the radially inner surface and the radially outer surface together define a tube wall therebetween, and wherein the radially inner surface defines a fluid passage for conveying fluid through the tube; providing a sleeve having a radially inner surface, wherein the radially inner surface of the sleeve proximal the flange portion includes a relief cavity; disposing the exemplary sleeve about the axial end portion of the tube; deforming the axial end portion of the tube with a forming tool in a direction radially outwardly and axially toward the sleeve to form a flange against an axial end surface of the sleeve; wherein the deforming includes directing material of the axial end portion of the tube into the relief cavity defined by the proximal portion of the radially inner surface of the sleeve.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A flanged tube assembly, comprising:
a tube having a longitudinal axis, an axial end portion, a radially inner surface, and a radially outer surface, wherein the radially inner surface and the radially outer surface together define a tube wall therebetween, and wherein the radially inner surface defines a fluid passage for conveying fluid through the tube;
a sleeve disposed on the radially outer surface of the tube at the axial end portion of the tube; and
the axial end portion of the tube including a flange portion that is formed by the tube wall being radially outwardly deformed over an axial end surface of the sleeve;
wherein the sleeve has a radially inner surface, and a portion of the tube wall inside of the sleeve is deformed to engage and conform to the radially inner surface of the sleeve, thereby providing a non-welded connection between the sleeve and the tube; and
wherein the radially inner surface of the sleeve proximal the flange portion defines a relief cavity that receives the deformed portion of tube wall when the tube wall is deformed during the formation of the flange portion.

2. The flanged tube assembly according to claim 1, wherein the radially inner surface of the sleeve includes a distal portion that is distal the flange portion and a proximal portion that is proximal the flange portion, the proximal portion defining the relief cavity, and
wherein the proximal portion defining the relief cavity is radially outwardly enlarged relative to the distal portion.

3. The flanged tube assembly according to claim 2, wherein the proximal portion defining the relief cavity extends in an axial direction with a uniform diameter;
wherein the distal portion extends in the axial direction with a uniform diameter; and
wherein the diameter of the proximal portion defining the relief cavity is greater than the diameter of the distal portion.

4. The flanged tube assembly according to claim 2, wherein the radially inner surface of the sleeve further includes a radially outwardly tapered surface that connects the distal portion with the proximal portion defining the relief cavity.

5. The flanged tube assembly according to claim 1, wherein the proximal portion defining the relief cavity is curved in the axial direction.

6. The flanged tube assembly according to claim 1, wherein the proximal portion defining the relief cavity is radially outwardly tapered as the radially inner surface extends in the axial direction toward the flange portion.

7. The flanged tube assembly according to claim 1, wherein the axial end surface of the sleeve proximal the flange portion is a flat surface that is perpendicular to the longitudinal axis.

8. The flanged tube assembly according to claim 1, wherein the axial end surface of the sleeve proximal the flange portion is an inclined surface that is inclined to a plane perpendicular to the longitudinal axis, the inclined surface extending radially outwardly as the inclined surface extends in the axial direction toward the flange portion.

9. The flanged tube assembly according to claim 2, wherein the distal portion of the radially inner surface of the sleeve includes one or more radially inwardly protruding ridges and one or more radially outwardly recessed grooves that together provide a grip for engaging the radially outer surface of the tube.

10. The flanged tube assembly according to claim 2, wherein the distal portion of the radially inner surface of the sleeve has a uniform diameter as the distal portion extends in the axial direction.

11. The flanged tube assembly according to claim 1, wherein the sleeve has a radially outer surface, the radially outer surface having a narrow portion distal the flange portion, and the radially outer surface having a land portion proximal the flange portion that radially outwardly protrudes relative to the narrow portion.

12. The flanged tube assembly according to claim 11, wherein the narrow portion of the radially outer surface includes a tapered surface at a distal end of the sleeve that is tapered radially inwardly toward the tube.

13. The flanged tube assembly according to claim 11, wherein the land portion of the radially outer surface includes a tapered surface toward a proximal end of the sleeve that is tapered radially inwardly toward the tube.

14. The flanged tube assembly according to claim 1, wherein the flange portion includes a mating surface formed by the tube wall that engages and conforms to the axial end surface of the sleeve when the tube is deformed.

15. The flanged tube assembly according to claim 1, wherein the flange portion has an axial end face formed by the tube wall that is flat and perpendicular to the longitudinal axis.

16. A method of making a flanged tube assembly, comprising:
providing a tube having a longitudinal axis, an axial end portion, a radially inner surface, and a radially outer surface, wherein the radially inner surface and the radially outer surface together define a tube wall therebetween, and wherein the radially inner surface defines a fluid passage for conveying fluid through the tube;
providing a sleeve having a radially inner surface, wherein the radially inner surface of the sleeve proximal the flange portion includes a relief cavity;
disposing the exemplary sleeve about the axial end portion of the tube;
deforming the axial end portion of the tube with a forming tool in a direction radially outwardly and axially toward the sleeve to form a flange against an axial end surface of the sleeve;
wherein the deforming includes directing material of the axial end portion of the tube into the relief cavity defined by the proximal portion of the radially inner surface of the sleeve.
